(19) United States
(12) Patent Application Publication
(10) Pub. No.: US 2004/0037532 A1
(43) Pub. Date: Feb. 26, 2004

(54) Optical waveguide and method for manufacturing the same

(76) Inventors: Sun Tak Park, Daejon-Shi (KR); Myung Hyun Lee, Daejon-Shi (KR); Jung Jin Ju, Daejon-Shi (KR); Jung Yun Do, Daejon-Shi (KR); Seung Koo Park, Daejon-Shi (KR)

Correspondence Address: JACOBSON HOLMAN PLLC, 400 SEVENTH STREET N.W., SUITE 600, WASHINGTON, DC, 20004, US

(21) Appl. No.: 10/321,817

(22) Filed: Dec. 18, 2002

(30) Foreign Application Priority Data
Aug. 21, 2002 (KR) 2002-49379

(51) Int. Cl. G02B 6/10

(52) U.S. Cl. 385/131

(57) ABSTRACT

The present invention relates to an optical waveguide and method of manufacturing the same. An optical waveguide is constructed using a clad layer having a refractive index almost same to a core layer in an input/output region coupled to an optical fiber. The optical waveguide is constructed using the clad layer having a large difference in the refractive index with the core layer in an active region having an electrode. Therefore, a driving voltage, a driving power and a coupling loss are reduced to improve a characteristic of the optical waveguide device.

### BACKGROUND OF THE INVENTION

1. Field of the Invention

The invention relates generally to an optical waveguide and method of manufacturing the same. More particularly, the invention relates to an optical waveguide and method of manufacturing the same, capable of reducing a driving voltage, a driving power and a coupling loss of an electro-optic waveguide device or a thermo-optic waveguide device.

2. Description of the Prior Art

An optical waveguide includes a core layer through which light passes, and cladding layers surrounding the core layer for allowing the total reflection of light. This optical waveguide is manufactured on various substrates through a thin film manufacture process, a diffusion control process, or the like. This type of the optical waveguide is called a planar optical waveguide.

The planar optical waveguide device includes a passive device in which the effective refractive index of the waveguide cannot be controlled after fabricating the optical waveguide, and an active device in which it can be controlled using an electro-optic effect, an acoustic optical effect, a thermo-optic effect, and the like.

Of the optical waveguide devices described above, the optical waveguide device using the electro-optic effect (hereinafter called ‘electro-optic waveguide device’) is one that is driven using variation in the refractive index of the core layer by applying an electric field between the optical waveguides. The type of the electro-optic waveguide device may include a modulator, a switch, or the like having Mach-Zehnder interferential structure. In order to reduce the driving voltage of the electro-optic waveguide device, it is required that the total thickness of the optical waveguide be reduced so that the distance between modulation electrodes can be minimized.

For this, it is required that a guiding light be confined to a very thin core layer by making large the difference in the refractive index between the core layer and the clad layer in the optical waveguide, or the total thickness of the optical waveguide be sufficiently thin by making very thin the thickness of the clad layer. In this case, however, as the mode size of the guiding light becomes very smaller than that of an optical fiber, there are disadvantages that coupling loss occurs due to mode mismatching and a tolerance error becomes very small upon alignment of the optical fiber.

On the other hand, the optical waveguide device using the thermo-optic effect (hereinafter called ‘thermo-optic waveguide device’) is one that serves as a switch using variation in the refractive index of the optical waveguide depending on variation in the temperature of the core layer or the clad layer. Thermo-optic waveguide device has a structure in which an applied heat is transmitted from the surface of the electrode to a desired portion to change the refractive index and a heat is emitted using an underlying thermal-absorption material. The type of the thermo-optic waveguide device may include a directional coupler, a X-switch, a dual mode interference switch, a switch connected to a Y-branch, a digital switch using a mode evolution principle, or the like. In order to reduce the driving power of the thermo-optic waveguide device, it is required that the total thickness of the optical waveguide be reduced to rapidly transfer an applied heat from the electrode to the thermal-absorption material. Due to this, a low driving power may be used and the switching speed can be improved. In this case, however, there is a problem that the coupling loss is large due to a mode mismatching with the optical fiber.

As described above, the electro-optic waveguide device or the thermo-optic waveguide device has a high performance (i.e., driving voltage, driving power, switch speed) as the total thickness of the optical waveguide is thin. The electro-optic waveguide device or the thermo-optic waveguide device, however, has a high coupling loss with the optical fiber in an input/output region of the optical waveguide. In order to solve these problems, in a prior art, a method by which the coupling loss with the optical fiber becomes small by tapering the input/output region (i.e., a region to/from light is inputted/outputted) of the core layer to make small or wide the cross section of the core layer, is employed. However, in case that the cross section of the core layer is small, the exactness must be high since the tolerance error is very small upon alignment with the optical fiber. On the other hand, in case the cross section of the core layer is wide, it is difficult to apply a optical waveguide device using only a single mode since multi modes in the core layer exist.

### SUMMARY OF THE INVENTION

The present invention is contrived to solve the above problems and an object of the present invention is to provide an optical waveguide and method of manufacturing the same, capable of reducing the driving voltage, the driving power and the coupling loss of the electro-optic waveguide device or the thermo-optic waveguide device.

In order to accomplish the above object, an optical waveguide according to the present invention, is characterized in that it comprises a lower clad layer; a core layer formed on the lower clad layer, for transmitting a optical wave; and an upper clad layer formed on the core layer, wherein at least one of the upper clad layer and the lower clad layer includes at least two or more clad layers, and wherein the at least two clad layers has different the refractive indices so that the difference in the refractive index with the core layer is different in an input/output region into/from which the optical light is inputted/outputted and an active region in which the optical wave is modulated.

Further, a method of manufacturing an optical waveguide according to the present inventions is characterized in that it comprises the steps of providing a substrate that is divided into an input/output region connected to an optical fiber, and an active region for modulating an optical wave transmitted from the optical fiber; forming a lower clad layer on the substrate; coating a core on the lower clad layer and then patterning a portion of the core to form a core layer having the optical waveguide of a rib structure or a channel structure; forming a first upper clad layer on the core layer, having a refractive index smaller than the core layer; etching the first upper clad layer to expose an upper surface of the optical waveguide having the rib structure or the channel structure in the active region; and forming a second upper clad layer having a refractive index smaller than the first upper clad layer at a portion that was etched in the step.

In addition, a method of manufacturing an optical waveguide according to the present invention, is characterized in that it comprises the steps of providing a substrate that is divided into an input/output region connected to an optical fiber and an active region for modulating an optical wave transmitted from the optical fiber; forming a lower clad layer on the substrate; coating a core on the lower clad layer and then patterning a portion of the core to form a core layer having the optical waveguide of a rib structure or a channel structure; forming a first upper clad layer on the core layer, having a refractive index smaller than the core layer; etching the first upper clad layer to expose an upper surface of the optical waveguide having the rib structure or the channel structure in input/output region; and forming a second upper clad layer having a refractive index larger than the first upper clad layer at a portion that is etched in the step.

### BRIEF DESCRIPTION OF THE DRAWINGS

The aforementioned aspects and other features of the present invention will be explained in the following description, taken in conjunction with the accompanying drawings, wherein:

FIG. 1 is a lateral view of an electro-optic waveguide device according to a first embodiment of the present invention;

FIG. 2A is a cross-sectional view of the electro-optic waveguide device shown in FIG. 1 taken along line 1-1′;

FIG. 2A is a cross-sectional view of the electro-optic waveguide device shown in FIG. 1 taken along line II-II′;

FIG. 3A˜FIG. 3E are cross-sectional views of the electro-optic waveguide devices for explaining a method of manufacturing them;

FIG. 4 is a lateral view of an electro-optic waveguide device according to a second embodiment of the present invention;

FIG. 5A is a cross-sectional view of the electro-optic waveguide device shown in FIG. 4 taken along line 1-1′;

FIG. 5B is a cross-sectional view of the electro-optic waveguide device shown in FIG. 4 taken along line II-II′;

FIG. 6 is a graph for explaining variation in the coupling loss with an optical fiber depending on the refractive index of a second upper clad layer in the electro-optic waveguide device shown in FIG. 4;

FIG. 7 is a graph for explaining variation in the coupling loss with an optical fiber depending on the thickness of a core layer in the cited reference;

FIG. 8 is a graph for explaining variation in the coupling loss with an optical fiber depending on the refractive index of the second upper clad layer in case that U.S. Pat. No. 5,568,579 and a technical idea of the present invention are simultaneously applied; and

FIG. 9 is a lateral view of a thermo-optic waveguide device according to another embodiment of the present invention.

### DETAILED DESCRIPTION OF PREFERRED EMBODIMENTS

The present invention will be described in detail by way of a preferred embodiment with reference to accompanying drawings, in which like reference numerals are used to identify the same or similar parts.

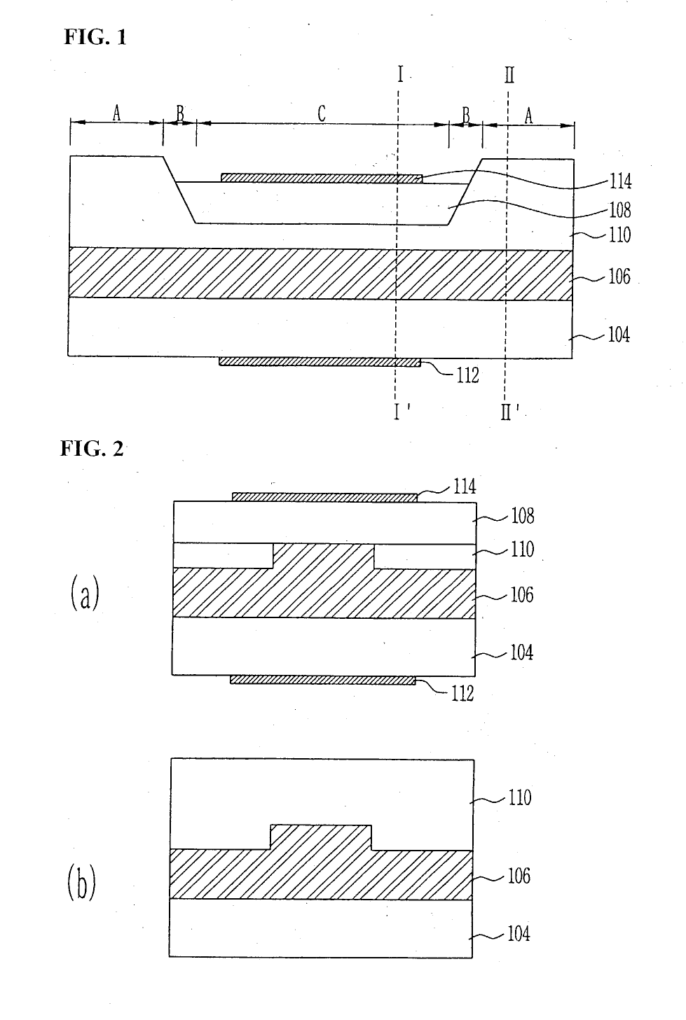

FIG. 1 is a lateral view of an electro-optic waveguide device according to a first embodiment of the present invention, FIG. 2A is a cross-sectional view of the electro-optic waveguide device shown in FIG. 1 taken along line 1-1′ and FIG. 2B is a cross-sectional view of the electro-optic waveguide device shown in FIG. 1 taken along line II-II′.

Referring now to FIG. 1, an electro-optic waveguide device according to a first embodiment of the present invention is divided into: an input/output passive optical waveguide region (A) (hereinafter called ‘input/output region’) for coupling an optical fiber to an input/output unit, an electro-optic modulating optical waveguide region (C) (hereinafter called ‘active region’) for electro-optically modulating a phase of a guiding light transmitted through the optical fiber, and a taper region (B) for connecting the input/output region (A) and the active region (C).

By reference to FIG. 2A, the active region (C) includes a lower clad layer 104, a core layer 106, a second upper clad layer 110 and a first upper clad layer 108, all of which are sequentially stacked between an upper electrode 114 and a lower electrode 112 for electro-optically modulating a phase of the guiding light. The second upper clad layer 110 is formed between the first upper clad layer 108 and the core layer 106. At this time, the second upper clad layer 110 is formed not to overlap with an upper portion of the optical waveguide (for example, the optical waveguide of a rib structure or a channel structure) in the core layer 106.

Referring now to FIG. 2B, the input/output region (A) includes the lower clad layer 104, the core layer 106 and the second upper clad layer 110, all of which are sequentially stacked on a substrate (not shown). In other words, the input/output region (A) does not have the first upper clad layer 108 formed in the active region (C).

In the above, it is preferred that the first upper clad layer 108 has the maximum difference in the refractive index with the core layer 106. It is further preferred that the second upper clad layer 110 has the minimum difference in the refractive index with the core layer 106. In particular, it is preferred that the second upper clad layer 110 has the refractive index higher than the first upper clad layer 108 but lower than the core layer 106, the reason of which will be described later.

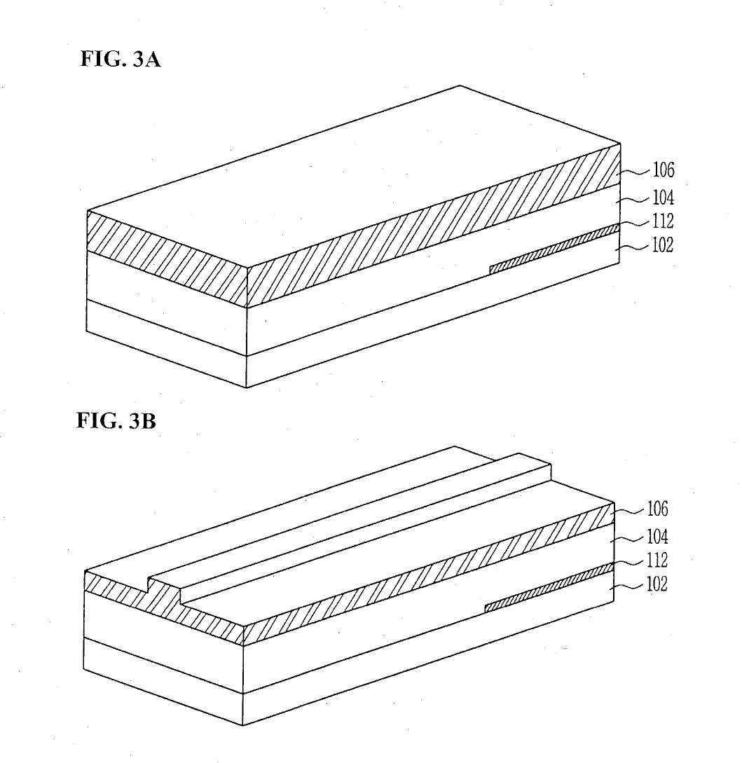

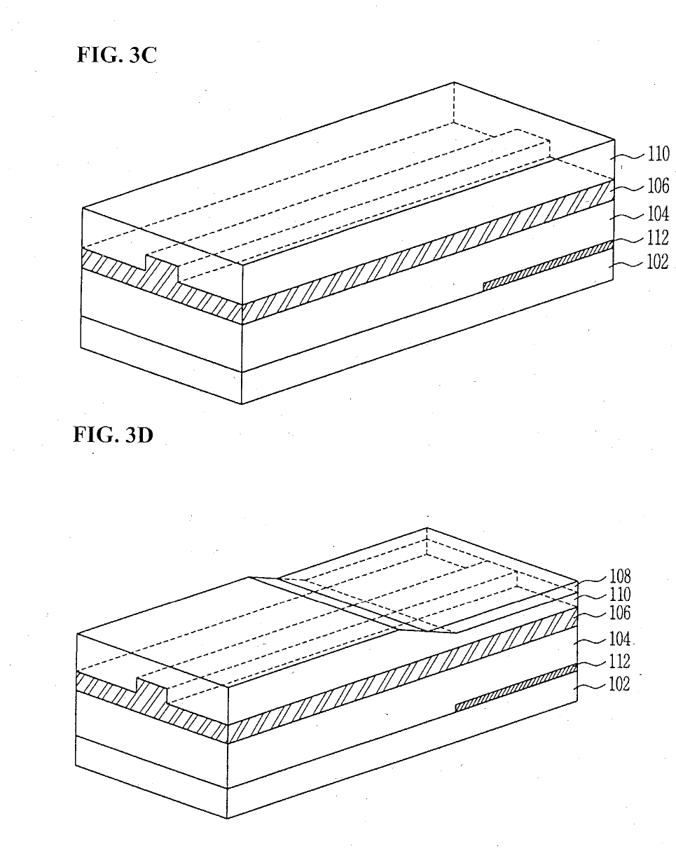

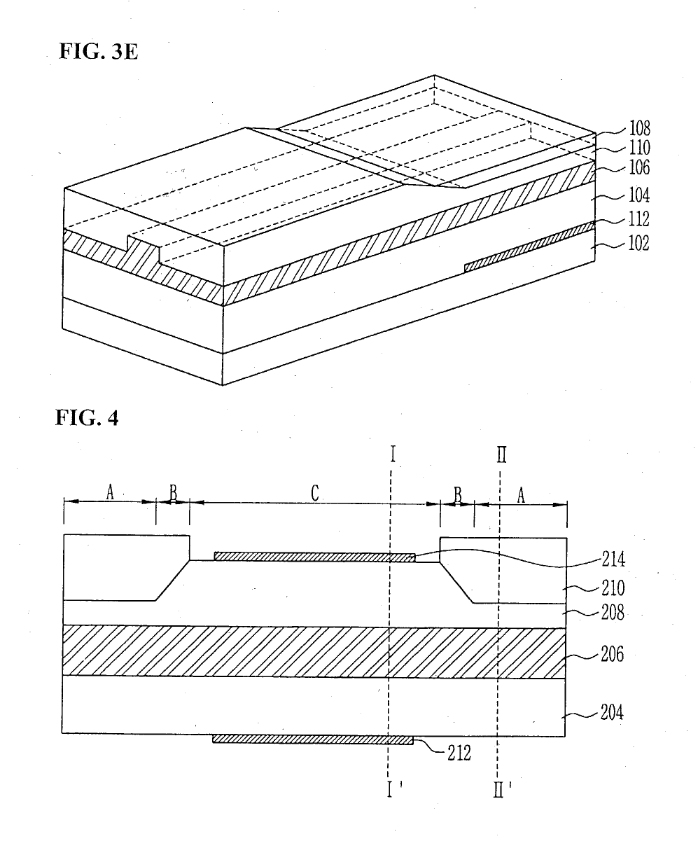

A method of manufacturing the electro-optic waveguide device according to the first embodiment of the present invention shown in FIG. 1, FIG. 2A and FIG. 2B will be below described in detail by reference to FIG. 3A˜FIG. 3E. For convenience of explanation, the reference numerals in FIG. 3A˜FIG. 3E are same to those in FIG. 1, FIG. 2A and FIG. 2B.

Referring now to FIG. 3A, a substrate 102 such as a silicon substrate, a III-V group semiconductor (InP, GaAs, etc.) substrate, a glass substrate, or the like is provided. The substrate 102 is then defined as an input/output region (A), a taper region (B) and an active region (C).

In the substrate 102, a lower electrode 112 is formed in the active region (C) through a vacuum deposition process.

Thereafter, the lower clad layer 104 and the core layer 106 are sequentially formed on the entire substrate 102. At this time, the lower clad layer 104 and the core layer 106 are formed using polymer, silica, semiconductor material, and the like. In case that the lower clad layer 104 and the core layer 106 are formed using polymer, it is preferred that a spin coating method is employed. In case that the lower clad layer 104 and the core layer 106 are formed using silica, semiconductor material, and the like, it is preferred that a chemical vapor deposition (CVD) method, a physical vapor deposition (PVD) method or an atomic layer deposition (ALD) method is employed.

Referring now to FIG. 3B, in order to form the optical waveguide of a rib structure or a channel structure at a part of the core layer 106, the part of the core layer 106 is patterned using dry etch, wet etch, reactive ion etching (RIE) method using oxygen ions.

By reference to FIG. 3C, a second upper clad layer 110 is formed on the entire structure by means of the spin coating method using polymer, or by means of the CVD method, the PVD method or the ALD method using silica, a semiconductor material, or the like. For example, it is preferred that the second upper clad layer 110 is formed to have a low difference in the refractive index with the core layer 106 so that the coupling loss with the optical fiber is low.

Referring now to FIG. 3D, the second upper clad layer 110 in the taper region (B) is obliquely etched to have a taper shape, and the second upper clad layer 110 in the active region (C) is etched so that a part of the core layer 106 having the optical waveguide of the rib structure or the channel structure among the core layers 106 is exposed, using an etch process using a shadow mask, for example, the RIE method.

Referring to FIG. 3E, the first upper clad layer 108 is formed in the active region (C) of the substrate 102 by means of the spin coating method using polymer, or by means of the CVD method, the PVD method or the ALD method using silica, a semiconductor material, or the like. In particular, it is preferred that the first upper clad layer 108 is formed using polymer by which the refractive index can be easily controlled, so that the difference in the refractive index with the core layer 106 is large. The reason is because the refractive index of a desired amount is easily obtained.

Next, an upper electrode (see ‘114’ in FIG. 1 and FIG. 2B) is formed on the first upper clad layer 108 through a vacuum deposition process. A process of manufacturing the electro-optic waveguide device is thus completed.

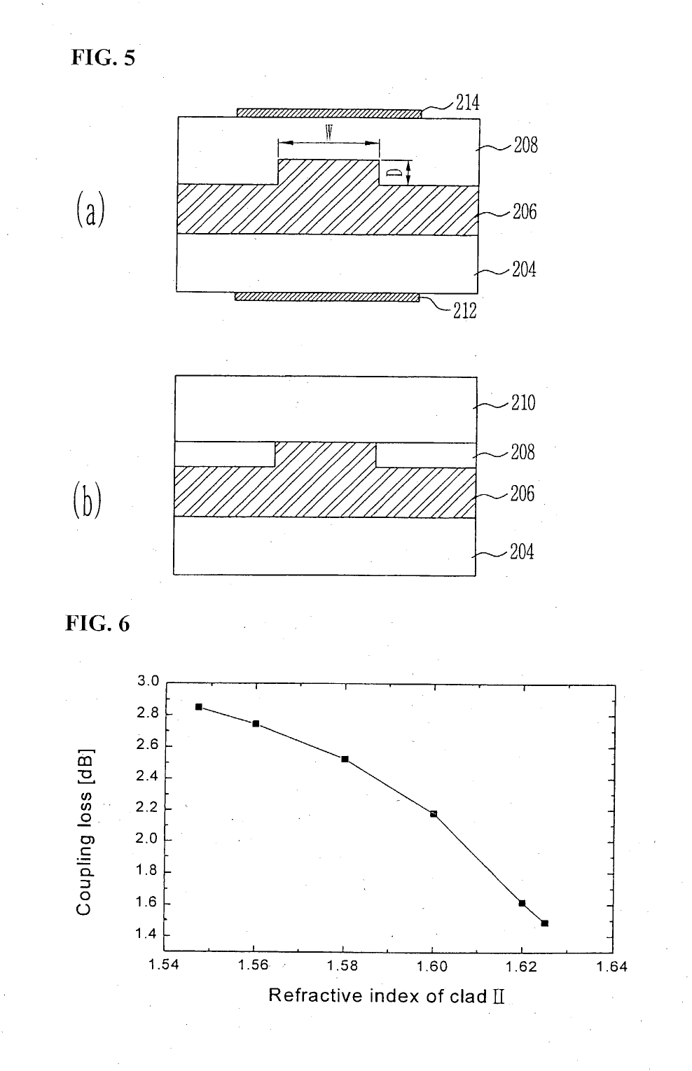

FIG. 4 is a lateral view of an electro-optic waveguide device according to a second embodiment of the present invention, FIG. 5A is a cross-sectional view of the electro-optic waveguide device shown in FIG. 4 taken along line 1-1′ and FIG. 5B is a cross-sectional view of the electro-optic waveguide device shown in FIG. 4 taken along line II-II′.

Referring now to FIG. 4, an electro-optic waveguide device according to the second embodiment of the present invention is divided into an input/output region (A) for coupling an optical fiber to an input/output unit, an active region (C) for electro-optically modulating a phase of a waveguide light transmitted through the optical fiber, and a taper region (B) for connecting the input/output region (A) and the active region (C).

By reference to FIG. 5A, the active region (C) includes a lower clad layer 204, a core layer 206 and a first upper clad layer 208 for electro-optically modulating a phase of the guiding light, all of which are sequentially stacked between the upper electrode 214 and the lower electrode 212. It should be noted that though the second upper clad layer 114 shown in FIG. 1 is formed in the active region (C) of the electro-optic waveguide device according to the first embodiment, the second upper clad layer (see ‘210’ in FIG. 4 and FIG. 5B) is not formed in the active region (C) of the electro-optic waveguide device according to the second embodiment of the present invention, as shown in FIG. 5A.

Referring now to FIG. 5B, the input/output region (A) includes the lower clad layer 204, the core layer 206, the first upper clad layer 208 and a second upper clad layer 210. At this time, the first upper clad layer 208 is formed between the second upper clad layer 210 and the core layer 206 so that it does not overlap with an upper portion of the optical waveguide of the core layer 206 (for example, the optical waveguide of a rib structure or a channel structure).

In the above, the refractive index of each of the first and second upper clad layers 208 and 210 is set to be same to that of the first and second upper clad layers 108 and 110 in the electro-optic waveguide device according to the first embodiment. In other words, the first upper clad layer 208 is formed so that the difference in the refractive index with the core layer 206 becomes the maximum. The second upper clad layer 210 is formed to have the difference in the refractive index with the core layer 206, same to the mode size of the optical fiber. At this time, the refractive index of the second upper clad layer 210 is larger than that of the first upper clad layer 208 but smaller than that of the core layer 206.

In the electro-optic waveguide device according to the second embodiment described above, the first upper clad layer 208 having a large difference in the refractive index with the core layer 206, and the second upper clad layer 210 having a small difference in the refractive index with the core layer 206 together are formed in the input/output region (A). As the difference in the refractive index of the core layer 206 is controlled to adjust the refractive index of the first and second upper clad layers 208 and 210, a margin by which the refractive index at the input/output region (A) can be controlled is increased, thus increasing the free degree in designing the optical waveguide device.

Further, unlike the structure shown in FIG. 2B, in the structure shown in FIG. 5B, the coupling loss with the optical fiber becomes further small when the width of the optical waveguide in the core layer is large. In the structure shown in FIG. 2B, the coupling loss with the optical fiber becomes further small when the width of the optical waveguide in the core layer is small.

A method of forming a structure of the electro-optic waveguide device according to the second embodiment is same to the method of manufacturing the electro-optic waveguide device according to the first embodiment described by reference to FIG. 3A˜FIG. 3E, except that several steps in the manufacturing method of the second embodiment are changed. More particularly, the manufacturing process of the first embodiment described by reference to FIG. 3C˜FIG. 3E comprises the steps of coating the second upper clad layer 110, etching the second upper clad layer 110 in the active region (C) and coating the first upper clad layer 108 in the active region (C). However, the manufacturing process of the second embodiment comprises the steps of coating the first upper clad layer 208, etching the first upper clad layer 208 in the input/output region (A) and coating the second upper clad layer 210 at a portion in which the first upper clad layer 208 in the input/output region (A) is coated.

As described above, in the electro-optic waveguide device according to the first and second embodiments, the first upper clad layers 108 and 208 are formed to have the maximum difference in the refractive index with the core layers 106 and 206, and the second upper clad layers 110 and 210 are formed to have the minimum difference in the refractive index with the core layers 106 and 206. The reason will be described in detail taking the electro-optic waveguide device according to the first embodiment as an example.

Generally, in order to lower the driving voltage of the electro-optic waveguide device, it is advantageous that the distance between the upper electrode 114 and the lower electrode 112 is narrow by maximum. The reason is because the intensity of an electric field against the same driving voltage is increased and the amount of an electro-optic phase modulation is thus increased, if the distance between the upper electrode 114 and the lower electrode 112 is narrow.

In the present invention, therefore, in order for the distance between the upper electrode 114 and the lower electrode 112 to be narrow by maximum, the first upper clad layer 108 having the largest difference in the refractive index with the core layer 106 (i.e., it is preferred that the difference in the refractive index is the largest) is formed in the active region (C). Accordingly, as the total thickness of the waveguide in the active region (C) is formed to be thin by maximum, the distance between the two electrodes 112 and 114 can be formed to be narrow by maximum. As a result, it is possible to lower the driving voltage of the electro-optic waveguide device. In other words, it is possible to control the total thickness of the waveguide when the optical waveguide is designed, by controlling the refractive index at the core layer 106 and the first upper clad layer 108 in the active region (C) to adjust the difference in the refractive index between the core layer 106 and the first upper clad layer 108.

As described above, however, if the difference in the refractive index between the core layer 106 and the first upper clad layer 108 becomes large in order to lower the driving voltage of the electro-optic waveguide device, the size of the guiding mode becomes further small than the mode size of the optical fiber. Due to this, the coupling loss with the optical fiber becomes large. In addition, there are problems that a process of exactly aligning and connecting the optical fiber is very difficult and additional optical loss is caused.

In the present invention, therefore, the second upper clad layer 110 having a small (i.e., almost same) difference in the refractive index with the core layer 106 is formed in the input/output region (A). Accordingly, as the mode size of the input/output region (A) becomes larger, the difference between the mode size of the input/output region (A) and the mode size of the optical fiber can be minimized. Further, if the refractive index of the second upper clad layer 110 is adequately controlled considering the refractive index of the core layer 106 and the structure of the waveguide, the mode size of the input/output region (A) can be formed to be almost same to that of the optical fiber. As a result, it is possible to minimize the coupling loss and to increase the tolerance error upon an alignment.

The description explained above will be described in detail by reference to characteristic graphs shown in FIG. 6˜FIG. 8.

FIG. 6 is a graph illustrating a result of calculating the coupling loss [dB] with the optical fiber depending on variation in the refractive index of the second upper clad layer (see ‘210’ in FIG. 4) in the electro-optic waveguide device according to the second embodiment. Calculation conditions are shown in Table 1.

TABLE 1

| | Lower Clad | First Upper | Second Upper | |
|---|---|---|---|---|
| | Layer | Clad Layer | Clad Layer | Core Layer |
| Thickness | 3 | 3 | 3 | 2.5 |
| (μm) | | | | |
| Refractive | 1.5471 | 1.547 | 1.5471˜1.625 | 1.63 |
| Index | | | | |

In addition to the conditions in Table 1, the following calculation conditions are added: the optical waveguide having the rib structure has the width (see ‘W’ in FIG. 5A) of 6 μm and the etch depth (see ‘D’ in FIG. 5A) of 0.2 μm. A wavelength used in the calculation is 1.55 μm.

As shown in FIG. 6, after the refractive index of the first upper clad layer (see ‘208’ in FIG. 4) is set to 1.5471 and the refractive index of the core layer (see ‘206’ in FIG. 4) is set to 1.63, the refractive index of the second upper clad layer 210 is changed from 1.5471 to 1.625. Then, the coupling loss with the optical fiber depending on variation in the refractive index of the second upper clad layer 210 is calculated.

If the refractive index of the second upper clad layer 210, 1.5471, is same to that of the first upper clad layer 208 (i.e., in case that the upper clad layer is one), the coupling loss with optical fiber is 2.58 dB. If the refractive index of the second upper clad layer 210 approaches from 1.625 to that of the core layer 206 (i.e., in case that the upper clad layer is two), the coupling loss with the optical fiber is reduced to 1.5 dB. In other words, as the refractive index of the second upper clad layer 210 approaches to that of the core layer 206, it can be seen that the coupling loss with the optical fiber is reduced.

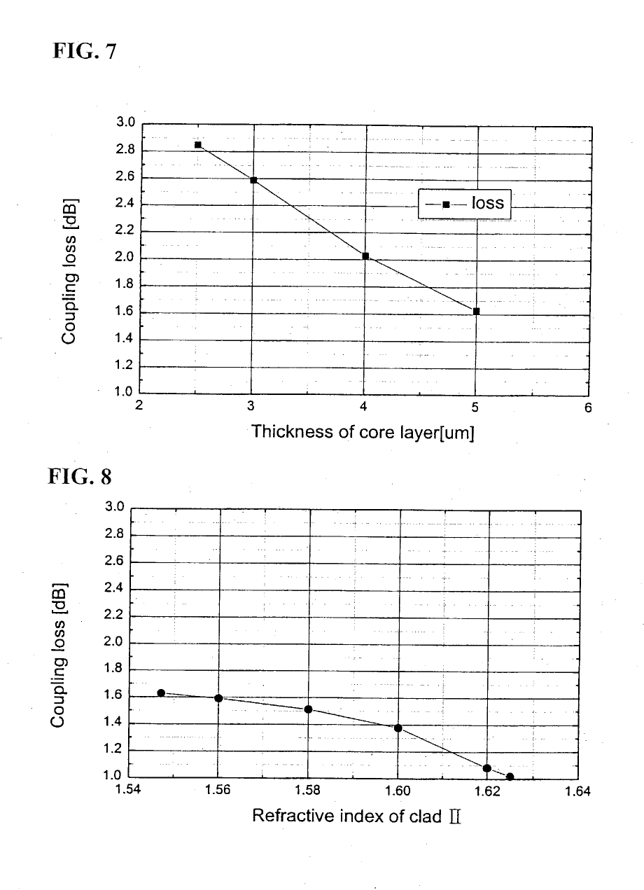

Meanwhile, FIG. 7 is a graph illustrating the coupling loss [dB] with the optical fiber depending on an increase in the thickness [μm] of the core layer in the input/output region, when an optical waveguide device disclosed in U.S. Pat. No. 5,568,579 entitled “Waveguide Coupling Device Including Tapered Waveguide With A Particular Tapered Angle To Reduce Coupling Loss” by K, Oksniwa et al, Oct. 22, 1996 is applied.

As shown in FIG. 7, it can seen that the coupling loss is reduced from 2.58 dB to 1.63 dB if the thickness of the core layer in the input/output region is increased from 2.5 82 m to 5 μm. In other words, if the thickness of the core layer in the input/output region is increased, the coupling loss with the optical fiber is reduced.

FIG. 8 is a graph illustrating a result of calculating the coupling loss [dB] with the optical fiber depending on variation in the refractive index of the second upper clad layer in the input/output region, when the technical idea of the present invention is applied to the optical waveguide device disclosed in the U.S. Pat. No. 5,568,579.

As shown in FIG. 8, if the thickness of the core layer is set to 5 μm and the refractive index of the second upper clad layer in the input/output region is increased from 1.545 to 1.625 in order to reduce the difference in the refractive index with the core layer, it can be seen that the coupling loss with the optical fiber is reduced from 1.63 dB to 1 dB. In other words, in the U.S. Pat. No. 5,568,579, the coupling loss is reduced to 1.63 dB by setting the thickness of the core layer to 5 μm, as shown in FIG. 7. However, if the present invention is applied to the U.S. Pat. No. 5,568,579, the coupling loss with the optical fiber is reduced to 1 dB, as shown in FIG. 8.

Only the electro-optic waveguide device has so far been described for the purpose of explaining the technical idea of the present invention but the explanation is only one example. It should be thus understood that the technical idea of the present invention is not limited to the electro-optic waveguide device. Therefore, the thermo-optic waveguide device to which the technical idea of the present invention is applied will be below described as an example.

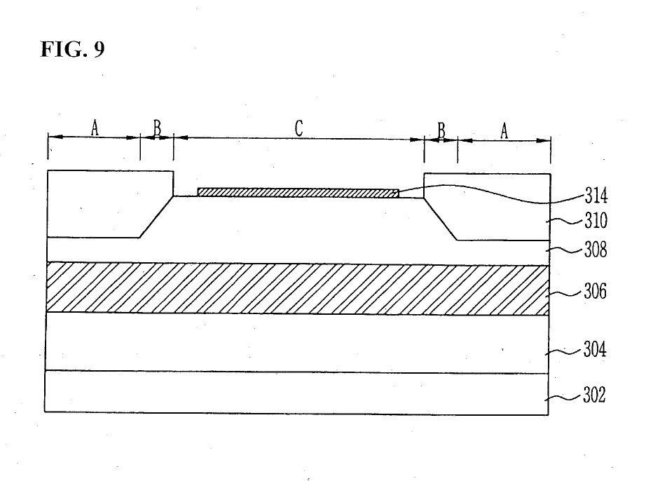

FIG. 9 is a lateral view of the thermo-optic waveguide device according to another embodiment of the present invention.

The thermo-optic waveguide device of the present invention has the same structure to the electro-optic waveguide devices shown in FIG. 1 and FIG. 4. For convenience of explanation, a structure of the electro-optic waveguide device shown in FIG. 4 will be thus described as an example.

Referring now to FIG. 9, the thermo-optic waveguide device is divided into an input/output region (A), a taper region (B) and an active region (C), which are same to the electro-optic waveguide devices shown in FIG. 1 and FIG. 4.

The active region (C) includes a lower clad layer 304, a core layer 306 and a first upper clad layer 308, all of which are sequentially stacked between an upper electrode 314 and a substrate 302 for a thermal-absorption material for modulating a phase of the guiding light using the thermo-optic effect. The input/output region (A) includes the lower clad layer 304, the core layer 306, the first upper clad layer 308 and a second upper clad layer 310.

In the above, the first upper clad layer 308 is formed to have the maximum difference in the refractive index with the core layer 306. It is thus possible to reduce the thickness of the optical waveguide. Due to this, a heat generated from the upper electrode 314 can be rapidly transmitted to the core layer 306 and can be also rapidly emitted toward the substrate 302 for the thermal-absorption material. As a result, it is possible to reduce the driving power of the optical waveguide device and to improve the switching speed of the optical waveguide device. The second upper clad layer 310 is formed to have the minimum difference in the refractive index with the core layer 306. At this time, the refractive index of the second upper clad layer 301 is larger than that of the first upper clad layer 308 but is smaller than that of the core layer 306. It is thus possible to minimize the coupling loss with the optical fiber.

Though the technical idea of the present invention described above has been described in detail by reference to the preferred embodiments, it should be noted that those embodiments are only for explanation. Thus, it should be noted that the present invention is not limited to those embodiment. In particular, though the technical idea of the present invention has been described by applying the preferred embodiments only to the upper clad layer, it should be noted that this is only one example. Therefore, the present invention can be applied to both the lower clad layer and/or the upper/lower clad layers. This can be sufficiently implemented based on the above-described contents. In addition, though only he upper and lower clad layers are used, it should be noted that at least two or more clad layers might be used.

As mentioned above, according to the present invention, the optical waveguide is constructed using the clad layer having a small difference in the refractive index with the core layer in the input/output region coupled to an optical fiber. Also, the optical waveguide is constructed using the clad layer having a large difference in the refractive index with the core layer in the active region. Therefore, the present invention has advantages that it can reduce the driving voltage, the driving power and the coupling loss and thus improve a characteristic of the optical waveguide device.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed is:

1. An optical waveguide, comprising:
a lower clad layer;
a core layer formed on the lower clad layer, for transmitting an optical wave; and
an upper clad layer formed on the core layer,
wherein at least one of the upper clad layer and the lower clad layer includes at least two clad layers, and
wherein the at least two clad layers have different refractive indices from a refractive index of the core layer in an input/output region, into/from which the light is inputted/outputted, and an active region, in which the optical wave is modulated.

2. The optical waveguide as claimed in claim 1, wherein the difference in the refractive index is large in the active region than that of the input/output region.

3. The optical waveguide as claimed in claim 1, wherein the clad layer having a large refractive index, among the at least two clad layers, is formed in the input/output region.

4. The optical waveguide as claimed in claim 1, wherein the clad layer having a large refractive index, among the at least two clad layers of the upper clad layer, is extended from the input/output region to the active region wherein the clad layer is thicker in the input/output region than in the active region.

5. The optical waveguide as claimed in claim 1, wherein the clad layer having a large refractive index, among the at least two clad layers of the upper clad layer, is separated at both sides centering around the optical waveguide of a rib structure or a channel structure of the core layer in the active region.

6. The optical waveguide as claimed in claim 1, wherein the clad layer having a large refractive index, among the at least two clad layers of the upper clad layer, has a taper region of a slant surface from the input/output region toward the active region in a region near the input/output region and the active region.

7. The optical waveguide as claimed in claim 6, wherein a portion of the taper region is overlapped, in a taper shape, with a portion of the clad layer having a small the refractive index among the at least two clad layers of the upper clad layer.

8. The optical waveguide as claimed in claim 1, wherein the clad layer having a large refractive index, among the at least two clad layers of the upper clad layer, is overlapped with the clad layer of the at least two clad layers having a small refractive index, among the upper clad layers, in the active region.

9. The optical waveguide as claimed in claim 1, wherein the clad layer having a small refractive index, among the at least two clad layers of the upper clad layer, is extended from active region to the input/output region, wherein the thickness of the clad layer is thicker in the active region than in the input/output region.

10. The optical waveguide as claimed in claim 1, wherein the clad layer having a small refractive index, among the at least two clad layers of the upper clad layer, has a taper region of a slant surface from the active region toward the input/output region in a region near the active region and the input/output region.

11. The optical waveguide as claimed in claim 10, wherein a portion of the taper region is overlapped, in a taper shape, with a portion of the clad layer having a large the refractive index among the at least two clad layers of the upper clad layer.

12. The optical waveguide as claimed in claim 1, wherein the clad layer having a small refractive index, among the at least two clad layers of the upper clad layer, is overlapped with the clad layer having a large refractive index among the at least clad layers of the upper clad layer in the input/output region.

13. The optical waveguide as claimed in claim 1, wherein the clad layer having a small refractive index, among the at least two clad layers of the upper clad layer, is separated at both sides centering around the optical waveguide of a rib structure or a channel structure of the core layer in the input/output region.

14. The optical waveguide as claimed in claim 1, wherein said active region further includes:
an upper electrode formed on the upper clad layer, for modulating the optical wave using an electro-optic effect; and
a lower electrode formed below the lower clad layer.

15. The optical waveguide as claimed in claim 1, wherein said active region further includes:
an upper electrode formed on the upper clad layer, for modulating the optical wave using a thermo-optic effect; and
a thermal-absorption layer formed below the lower clad layer.

16. The optical waveguide as claimed in claim 15, wherein the thermal-absorption layer functions as a substrate.

17. A method of manufacturing an optical waveguide, comprising the steps of:
(a) providing a substrate that is divided into an input/output region connected to an optical fiber and an active region for modulating an optical wave transmitted from the optical fiber;
(b) forming a lower clad layer on the substrate;
(c) coating a core on the lower clad layer and then patterning a portion of the core to form a core layer having the optical waveguide of a rib structure or a channel structure;
(d) forming a first upper clad layer having a refractive index smaller than the core layer, on the core layer;
(e) etching the first upper clad layer to expose an upper surface of the optical waveguide having the rib structure or the channel structure in the active region; and
(f) forming a second upper clad layer having a refractive index smaller than the first upper clad layer at a portion that was etched in the step (e).

18. The method as claimed in claim 17, further comprising the step of forming a lower electrode on the substrate of the active region before the step (b).

19. The method as claimed in claim 17, further comprising the step of forming an upper electrode on the second upper clad layer of the active region after the step (f).

20. The method as claimed in claim 17, wherein said substrate is one of a silicon substrate, a III-V group semiconductor substrate and a glass substrate.

21. The method as claimed in claim 17, wherein said substrate is a substrate for a thermal-absorption material.

22. The method as claimed in claim 17, wherein in the step (e), the first upper clad layer is obliquely etched in a taper shape toward the active region.

23. A method of manufacturing an optical waveguide, comprising the steps of:.
(a) providing a substrate that is divided into an input/output region connected to an optical fiber and an active region for modulating an optical wave transmitted from the optical fiber;
(b) forming a lower clad layer on the substrate;
(c) coating a core on the lower clad layer and then patterning a portion of the core to form a core layer having the optical waveguide of a rib structure or a channel structure;
(d) forming a first upper clad layer on the core layer, having a refractive index smaller than the core layer;
(e) etching the first upper clad layer to expose an upper surface of the optical waveguide having the rib structure or the channel structure in input/output region; and
(f) forming a second upper clad layer having a refractive index larger than the first upper clad layer at a portion that is etched in the step (e).

24. The method as claimed in claim 23, wherein in the step (e), the first upper clad layer is obliquely etched in a taper shape toward the input/output region.
